(19) United States
(12) Patent Application Publication
(10) Pub. No.: US 2012/0331459 A1
(43) Pub. Date: Dec. 27, 2012

(54) Electronic Control System for a Machine

(76) Inventor: Dhiren J. Master, Canmore (CA)

(21) Appl. No.: 13/146,539

(22) PCT Filed: Feb. 14, 2011
(86) PCT No.: PCT/CA11/50086

§ 371 Date: Jul. 27, 2011

Related U.S. Application Data
(60) Provisional application No. 61/308,343, filed on Feb. 26, 2010.

(51) Int. Cl. G06F 9/445

(52) U.S. Cl. 717/178

(57) ABSTRACT

A machine such as a domestic appliance is designed by providing a controller that has a generic PSoC as part of the controller board and includes interfaces specifically designed for cooperation with the input sensors and output controls. The machine is serviced by a method comprising providing a hand held unit which can communicate through the internet with a database providing software for the PSoC of the SPCB circuit board, providing on the SPCB an interface for local communication with the hand held unit and causing the hand held unit to communicate with the database of machines, stored on the internet, to download software onto the PSoC of the machine.

This invention relates to an electronic control system for a machine such as a domestic appliance, vehicle, robot, game and the like. The system is particularly applicable to appliances such as fridges, cookers, toasters, kettles, food processors, microwaves, and various cleaning devices. Also many kinds of vehicles such as electric wheel chairs, automotive electronic components, together with domestic and industrial robots, various electronically controlled toys/models, surveillance systems all use similar systems. The machine concerned consists of various mechanical, electro-mechanical and electronic components. The electro-mechanical devices interface with the electronic components to control the various mechanical components of the machine.

### BACKGROUND OF THE INVENTION

There are a large number of machines/appliances that have a significant electronic component. The complexity and usage of these electronic components is increasing from even the simplest of domestic appliances (cookers, washing machines, vacuum cleaners etc.), to all kinds of vehicles, entertainment devices, industrial machines, medical equipment etc.

These devices are becoming increasingly more complex and costly to design, produce, maintain and fix. Furthermore, the rate at which new models are being launched means that the average maintenance engineer has great difficulty in keeping abreast of how a particular device works let alone the ability to fix it. The net result is that if a machine/appliance fails then usually it is difficult for the service engineer to diagnose where the problem is. The result is often that the machine/appliance cannot be fixed but is simply replaced. From this wastage occurs, as working components as well as non-working components are thrown away.

### SUMMARY OF THE INVENTION

According to one aspect of the invention there is provided a method for servicing remote machines where the machines have a Standard Programmable Circuit Board (“SPCB”) that has a PSoC as a component on the board, the method comprising:

providing a hand held unit which can communicate through the internet with a database providing software for the PSoC of the circuit board;

providing on the circuit board an interface for local communication with the hand held unit

and causing the hand held unit to communicate with the database of machines to download the machine specific software onto the PSoC of the machine.

Preferably the SPCB comprising of a PSoC is arranged for use on many different machines and communicates with switches and sensors on the machine through an interface designed or programed specifically for the machine.

Preferably the hand held unit is programed with a program for communication between the machine and the data base. The program is compatible with a large number of mobile operating systems (Apple Inc. iOS, RIM Blackberry OS, Microsoft Windows Mobile, Nokia Symbian, Google Android) on popular smart phones (including iPhone, Blackberry, Nokia, Android, HTC etc units) which when downloaded with the appropriate program can be utilised as the hand held unit.

Preferably the machine is faulty and the service is to effect a repair by a local repair man from information provided by the database.

Preferably the machine control system is designed by using a generic SPCB/PSoC which is programed for control of the various dedicated system of the machine.

In accordance with another aspect of the invention there is provided a machine designed in accordance with the above concepts.

The system described herein provides a unique and novel application of a chip called a PSoC (Programmable System on Chip) such as that manufactured by Cypress Semiconductor Corporation. There are a large number of existing patents that are various applications of PSoCs.

The arrangement described herein is not intended for initial design work on a new product such as in debugging and/or developing the logic. Rather the key point is the use of the Internet by way of portable units such as smart phones (such as iPhone/Blackberry, Android devices, Nokia etc.) that can access a database of machines/appliances that can be used to download full working debugged software onto standard programmable boards (SPCBs) that have a PSoC at the heart of the board. Such PSoCs are available with clock signals, samplers, i/o buffers, A/D and D/A convertors.

The present arrangement thus provides an internet database and software for portable units such as Smart phones for use in programming the PSoC of a remote machine.

This invention proposes a novel way of configuring the various building blocks of any machine/appliance that would reduce:

Development time;

Manufacturing cost;

Maintenance and servicing time and errors (eg replacing parts that are working);

Reduction in electronic waste (less replacement)

The solution is a novel application of a PSoC™, for example of the type manufactured by Cypress Semiconductor Corporation to, used to create a universal “Purpose Built—Electronic Control Board” “PB-ECB”. The PB-ECB can be used in any device that is electronically controlled. The same PB ECB can be used for any device because the components that are specific to the electronically controlled device, ie the sensors, input switches and electromechanical devices are separate from the PB-ECB. This allows a service engineer to better diagnose whether the problem is in the sensors, switches, electromechanical devices and/or in the controller (the PB ECB).

If the controller is the problem then the service engineer simply replaces the old controller (the PB ECB) with a brand new universal un-programmed PB ECB. The engineer then accesses the internet via a handheld device to download the specific software required to program the PB ECB for that particular machine. Once the software is loaded, the handheld device attaches to the device to PB ECB and programs it. The universal un-programmed PCB is now transformed into a custom controller for that particular machine.

### BRIEF DESCRIPTION OF THE DRAWINGS

One embodiment of the invention will now be described in conjunction with the accompanying drawings in which:

FIG. 1 is a schematic illustration of the electronic control of current PRIOR ART machines.

FIG. 2 is a schematic illustration of the electronic control of a machine according to the present invention.

FIG. 3 is a schematic illustration of an overview of a system for managing the control system of the machine of FIG. 2.

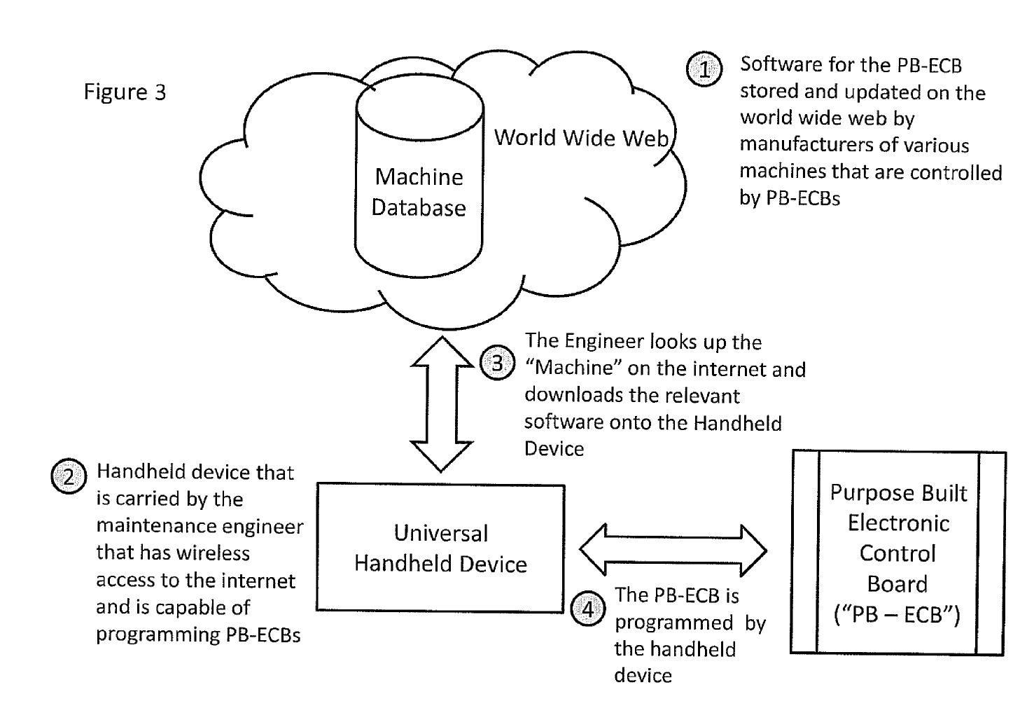

In the drawings like characters of reference indicate corresponding parts in the different figures.

### DETAILED DESCRIPTION

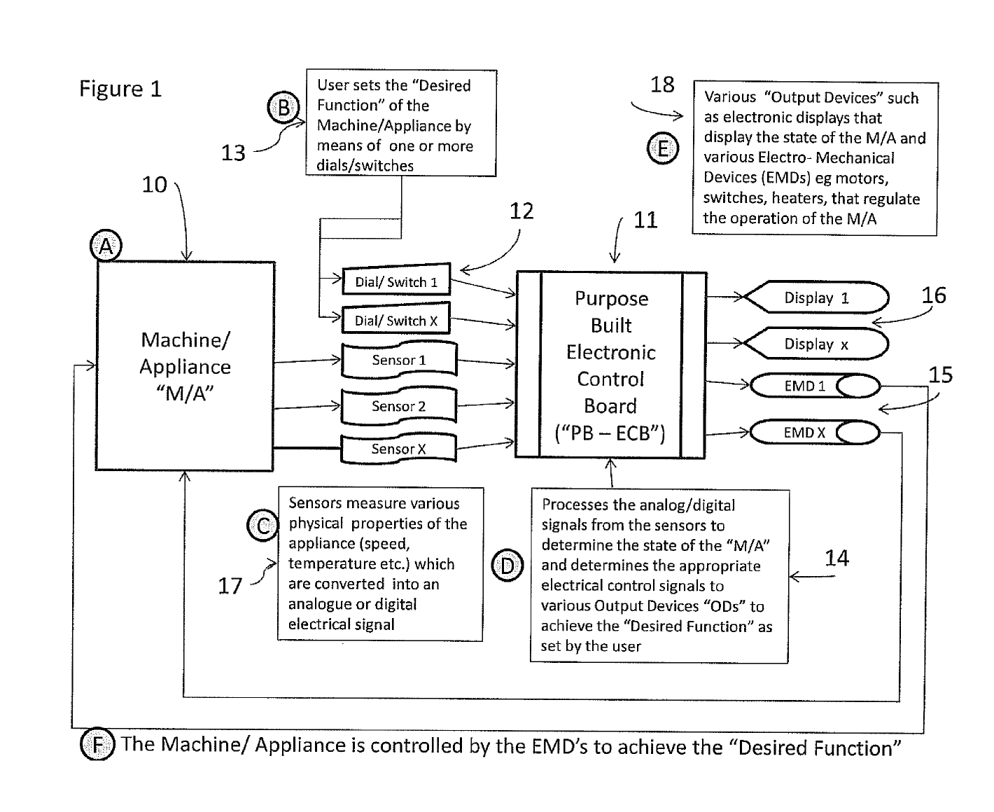

The current configuration of machines/appliances are schematically depicted as shown in FIG. 1.

There is a machine or appliance 10 which may be connected to other machines A to build up into a more complex machine. Examples of such machines are domestic appliances such as fridges, cookers, toasters, kettles, food processors, microwaves, and various cleaning devices. Also many kinds of vehicles such as electric wheel chairs, automotive electronic components, together with domestic and industrial robots, various electronically controlled toys/models, surveillance systems all use similar systems. The machine concerned consists of various mechanical, electro-mechanical and electronic components. The electro-mechanical devices interface with the electronic components to control the various mechanical components of the machine.

The design of the electronic circuit 11, including component choice and manufacturing and testing of the circuit boards are all bespoke to the particular machine. With each machine having its own “hardwired controller”. This makes the design and manufacturing process and on-going maintenance costly. Maintenance engineers need constant training which is costly and often not current, creating problems in maintaining and servicing.

As shown at 13, the user sets the desired function for example on/off, temperature, speed etc of the machine by the way of various switches and dials as indicated at 12. The inputs from these switches/dials are fed to the PB-ECB.

As shown at 17 typically sensors (not always present) measure various parameters (e.g. temperature, speed etc.) of the machine which are constantly sampled by the PB-ECB.

As shown at 14, the PB-ECB processes, using typically a combination of software and hardware, the signals from the switches and dials, as well as from the sensors to determine what motors/heaters/valves 15 to activate so that the desired operating function as determined by the user (via the switches/dials) is achieved. The PB-ECB also generates outputs fed to various electronic displays 16 so that the user is aware of the status of the machine. Thus as shown at 18, various electronically controlled motors/valves/switches to control the machine.

Currently the PB-ECB 11 is custom designed, and usually the switches, motors, sensor and display circuitry are also on the same PB-ECB. This configuration creates the problems of development cost, maintenance and repair. When one component fails the maintenance engineer has only one option which is to replace the entire electronic circuitry, in addition the engineer has to carry around or order specific custom PB-ECB's (which can be costly and can create significant time delays in fixing the appliance) for that particular model of machine. All of these factors lead to the problems under the current configuration.

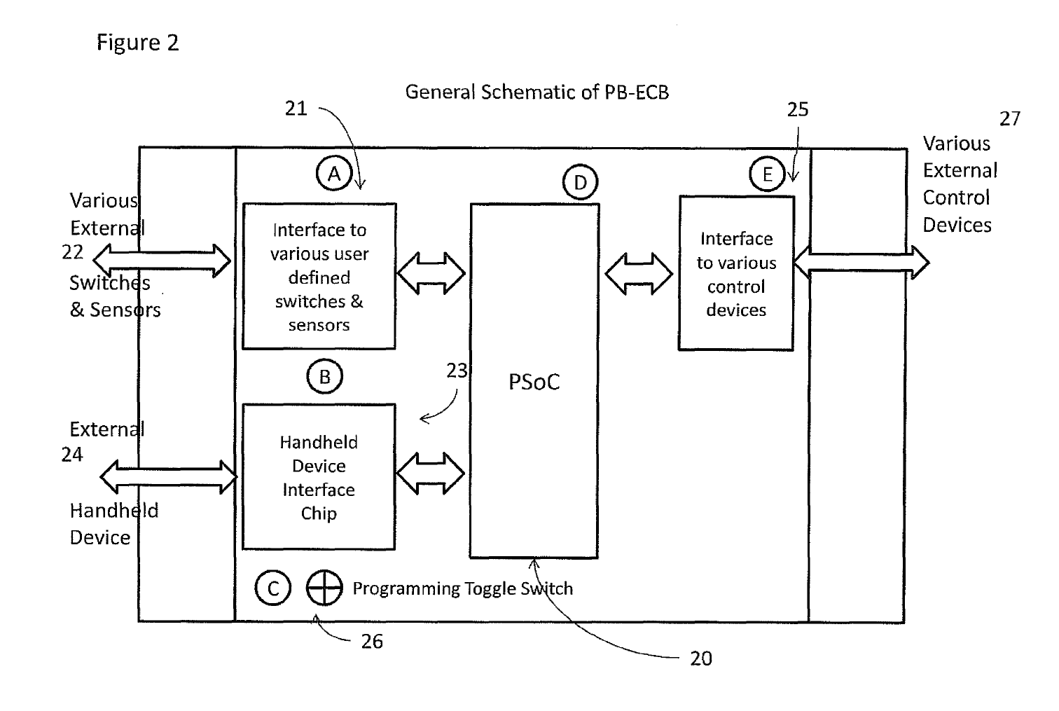

The new solution as shown in FIG. 2 disaggregates the various components of the current PB-ECB that will make it easier to diagnose and fix any maintenance problems, reduce maintenance cost, and reduce development and manufacturing costs. The layout is shown in FIG. 2. The new solution is to break down the PB-ECB into five component parts.

The core of the system is the PSoC 20 which is provided as a programable unit.

The PSoC is a Programmable System on Chip that can be of the type manufactured by Cypress Semi-Conductor Corporation which is available in many different configurations depending on the number of input and output devices that are needed to be controlled. The Universal Electronic Controller is a novel application for a PSoC. The PSoC 20 is the heart of the PB-ECB. The ability to have a standard layout is a key feature of this invention which reduces cost and time for development and maintenance.

An interface 21 is provided for communication with the PSoC 20 to various user defined switches 22. This is a standard buffer circuitry which has standard electrical connectors which the assembly or maintenance worker can simply attach to the dials/switches/sensors in the machine.

A handheld Device Interface Chip 23 is provided which is bespoke electronic circuitry that connects to a separate handheld unit 24. The handheld unit is capable of accessing the internet and downloading software specific for this machine which is temporarily stored onto the handheld unit. The handheld unit (via a USB connection) connects to HDIC 23. The software code that has been previously downloaded and saved onto the handheld device is now used to program the PSoC 20. The HDIC 23 is capable of programming the PSoC.

The handheld device 24 can be any Smart phone or PDA that has wireless access to the Internet, such as a Blackberry™, iPhone™, Nokia™, or Android™ supported devices which have the appropriate software to perform the above task on it. The software running on these universally available and popular Smart phones/PDAs is also a unique element of the solution.

A Programming Toggle Switch 26 which can be set to “Program Mode” or “Run Mode”. The field service engineer sets the Toggle Switch 26 to Program Mode” when they are programming the PSoC 20 and sets to Run Mode after the PSoC has been successfully programmed.

With a PSoC that can be programmed remotely on site by accessing software from the internet via any of the mainstream Smart phones (which have the appropriate driver software loaded onto it). The PSoC 20 after it has been programmed via the handheld device processes the input requirements via switches/dials and sensor inputs to generate control signals to control the various motors/valves to operate the machine as desired by the user.

The system includes an interface 25 to various Control Devices 27. This is an interface between the PSOC™ and control devices. The interface 25 has a series of clearly marked output pins that can be quickly and securely connected to various motors and valves that control the M/A.

Since various modifications can be made in my invention as herein above described, and many apparently widely different embodiments of same made within the spirit and scope of the claims without departing from such spirit and scope, it is intended that all matter contained in the accompanying specification shall be interpreted as illustrative only and not in a limiting sense.

1. A method for servicing a remote machine,
where the machines has a controller including a standard programmable circuit board (“SPCB”) that has a PSoC as part of the board, the method comprising:
providing a hand held unit which can communicate through the Internet with a database providing software for the PSoC of the SPCB circuit board;
providing on the SPCB an interface for local communication with the hand held unit;
and causing the hand held unit to communicate with the database of machines, stored on the internet, to download software onto the PSoC of the machine.

2. The method according to claim 1 wherein the PSoC is arranged for use on many different machines and wherein the controller is arranged to communicate with switches and sensors on the machine through an interface programed specifically for the machine.

3. The method according to claim 1 wherein the hand held unit is programed for communication between the machine and the data base.

4. The method according to claim 1 wherein the machine is defective and the service is to effect a repair by a local repair man from information provided by the database.

5. The method according to claim 1 wherein the machine control system is designed by using a generic PSoC which is programed for control of dedicated systems of the machine.

6. The method according to claim 1 wherein, in the event that the controller is defective, a service engineer replaces the defective controller with a new universal un-programmed controller, accesses the internet via the handheld unit to download the specific software required to program the controller for that particular machine, and once the software is loaded, the handheld unit communicates with the controller to program it.

7. The method according to claim 1 wherein an interface is provided for communication with the PSoC to various user defined switches.

8. The method according to claim 7 wherein the interface is a buffer circuitry which has electrical connectors to attach to the dials/switches/sensors in the machine.

9. The method according to claim 1 which includes an interface to various control devices of the machine.

10. The method according to claim 9 wherein the interface has a series of clearly marked output pins that can be quickly and securely connected to respective motors and valves that control the machine.
